(19) United States
(12) Patent Application Publication
(10) Pub. No.: US 2010/0156800 A1
(43) Pub. Date: Jun. 24, 2010

(54) ELECTRONIC DEVICE AND A DATA INPUT METHOD FOR THE ELECTRONIC DEVICE

(75) Inventor: MENG-CHIEH CHOU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/564,720

(22) Filed: Sep. 22, 2009

(30) Foreign Application Priority Data
Dec. 19, 2008 (CN) 200810306404.8

(51) Int. Cl. G06F 3/02

(52) U.S. Cl. 345/170

(57) ABSTRACT

An electronic device and a data input method for the electronic device are provided. The electronic device has keys and a display device. When a user depress one or more keys to complete data input, a set of values is acquired. To locate a data from a database of the electronic device, the acquired set of values is compared with standard values of the entries in the database. The standard values of the located data match the acquired set of values. The electronic device displays the located data on the display device.

### BACKGROUND

1. Technical Field

Embodiments of the present disclosure generally relate to an electronic device, and more particularly to a data input method for the electronic device.

2. Description of Related Art

Often, electronic devices, such as cell phones and personal digital assistants, feature a touch screen or keypad allowing input to operate the electronic device. If a touch screen is damaged, the keypad becomes the main input device. However, frequent use thereof may lead to malfunction of the keypad.

What is needed, therefore, is a data input method for the electronic device allowing diversification of input and increase the keypad lifetime.

### BRIEF DESCRIPTION OF THE DRAWINGS

FIG. 1 is a block diagram of one embodiment of an electronic device for data input.

FIG. 2 is a block diagram of function modules of a data input unit included in the electronic device of FIG. 1.

FIG. 3 is a front elevational view of an input device of the electronic device of FIG. 1.

FIG. 4 is a top plan view of the input device of FIG. 3.

FIG. 5 is a schematic graph illustrating each light sensor positioned under keys of the electronic device of FIG. 1 is set a serial number.

FIG. 6 is a flowchart illustrating changing of current characteristics in the system of FIG. 1.

FIG. 7 is a flowchart illustrating one embodiment of a data input method for an electronic device.

FIG. 8 is a schematic graph illustrating an example of standard values of a Chinese character for input.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the data “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

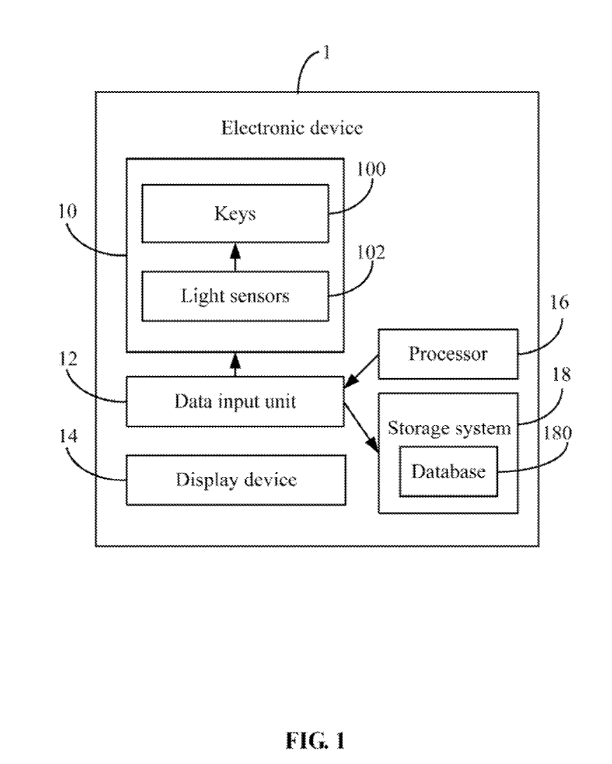

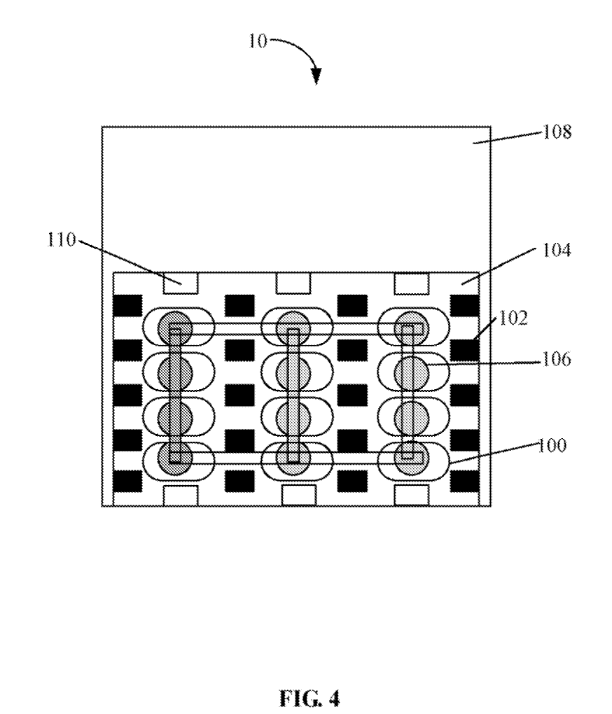

FIG. 1 is a block diagram of one embodiment of an electronic device 1 for data input. The electronic device 1 may be a mobile phone, a personal digital assistant, a personal computer or a game machine. Data input using the data input system includes, but is not limited to, a Chinese character, an English word, or other types of input. The electronic device 1 typically includes an input device 10, a data input unit 12, a display device 14, at least one processor 16, and a storage system 18. The input device 10 includes a plurality of keys 100, and a plurality of light sensors 102. In the embodiment, the light sensors 102 are disposed under each of the keys 100. As will be explained with reference to FIG. 4, four light sensors 102 may be respectively disposed under four different corners of each of the keys 100.

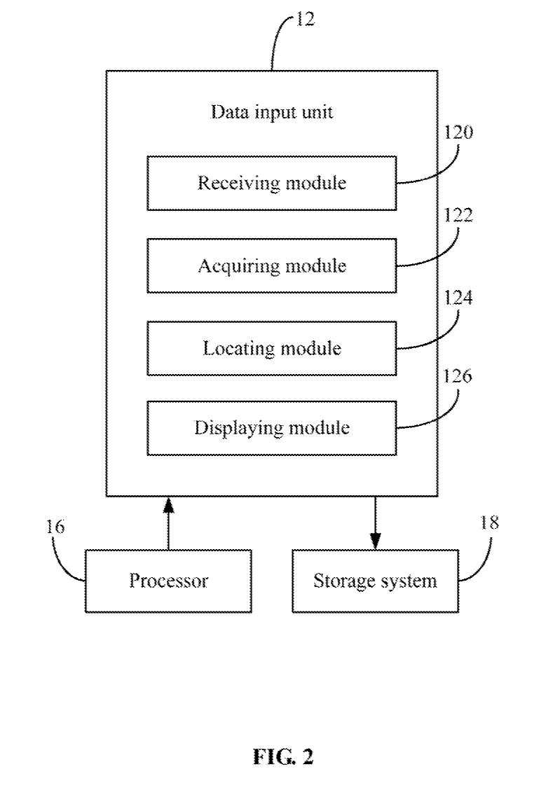

The data input unit 12 is operable to receive data input though a user-depression of the keys 100, and acquire a set of values from one or more keys 100 that have been depressed. The set of values includes serial numbers of the light sensors 102 positioned under each of the keys 100, and a current value change sequence of the one or more keys 100 that have been depressed. The data input unit 12 locates data from a database 180 of the storage system 18, and displays the located data on the display device 14. In the embodiment, the located data includes standard values that match the acquired set of values. In order to clearly illustrate the embodiment, more functions of the data input unit 12 are detailed below as shown in FIGS. 2-8. The at least one processor 16 implements the data input unit 12 which may be stored in the storage system 18 The storage system 18 may be a hard disk drive, a compact disc, a digital video disc, or a tape drive.

FIG. 2 is a block diagram of function modules of the data input unit 12. The data input unit 12 may include a plurality of instructions and executed by the at least one processor 16. In one embodiment, the data input unit 12 may include a receiving module 120, an acquiring module 122, a locating module 124, and a displaying module 126.

The receiving module 120 is operable to receive data input though a user-depression of the keys 100. As mentioned above, the data input may be a Chinese characters, or English words, for example.

The acquiring module 122 is operable to acquire a set of values from one or more keys 100 that have been depressed. In the embodiment, the set of values includes serial numbers of the light sensors 102 positioned under each of the keys 100, and a current value of current flowing to the light sensors 102 (hereinafter reference as “current value change sequence”) related to the one or more keys 100 that have been depressed. The current value change sequence includes a low current value changing to a high current value or a high current value changing to a low current value. Further details of the current value change sequence will be provided below.

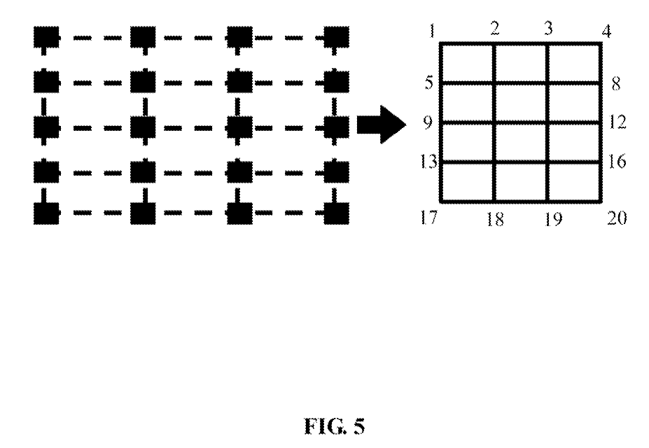

As an example, with respect to FIG. 5, the serial numbers of the light sensors 102 are set as “1, 2, 3 . . . 20.” When the one or more keys 100 are depressed, current characteristics of the light sensors 102 positioned under each of the keys 100 may change. If the current characteristics of each of light sensors “2,” “3,” “4” and “5” have changed successively, the acquiring module 122 acquires the set of values as “02030405.”

The locating module 124 is operable to locate data from the database 180, where the data includes standard values that match the acquired set of values, by comparing the acquired set of values with the standard values of the entries in the database 180.

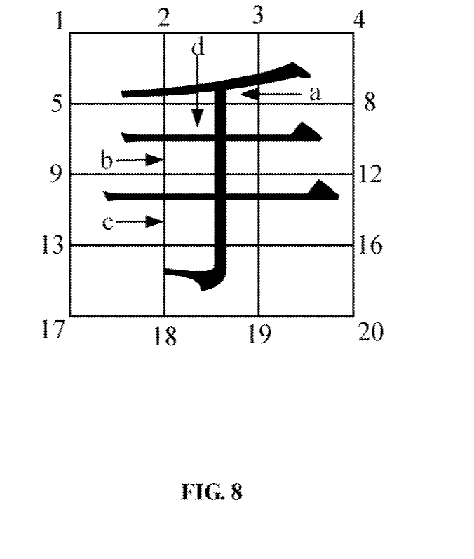

In the embodiment, the standard values include serial numbers of the light sensors 102 that experience a current value change sequence. It should be understood that the current value change sequence of the light sensors 102 of the keys 100 that have been depressed are related to the data input to the keys 100. For example, if the serial number of one of the light sensors 102 is set as “1” (hereinafter referenced as a first light sensor), where a low current value of the first light sensor is 0.45 microamperes and a high current value of the first light sensor is 0.55 μA, the current characteristics of the first light sensor is seen as a low current value changing to a high current value. FIG. 8 shows an example of the standard values for a Chinese character [symbol] as follows:

| | | | |
|---|---|---|---|
| 0302 | 0607 | 1011 | 0711151918 |
| 0706 | 1011 | 1415 | 0610141814 |
| 0302 | 1011 | 1011 | 0711151918 |
| 0706 | 0607 | 1011 | 0610151814, |

Serial numbers “0302” and “0706” represent a first stroke [symbol] of the Chinese character [symbol] serial numbers “0607” and “1011” represent a second stroke [symbol] of the Chinese character [symbol] serial numbers “1011” and “1415” represent a third stroke [symbol] of the Chinese character [symbol] serial numbers “0711151918,” “0610141814” and “0610151814” represent a fourth stroke [symbol] of the Chinese character

[symbol]

The displaying module 126 displays the located data on the display device 14.

In one embodiment, the serial numbers of the light sensors 102 are stored in the storage system 18. In another embodiment, the storage system 18 stores the current characteristics of each of the light sensors 102.

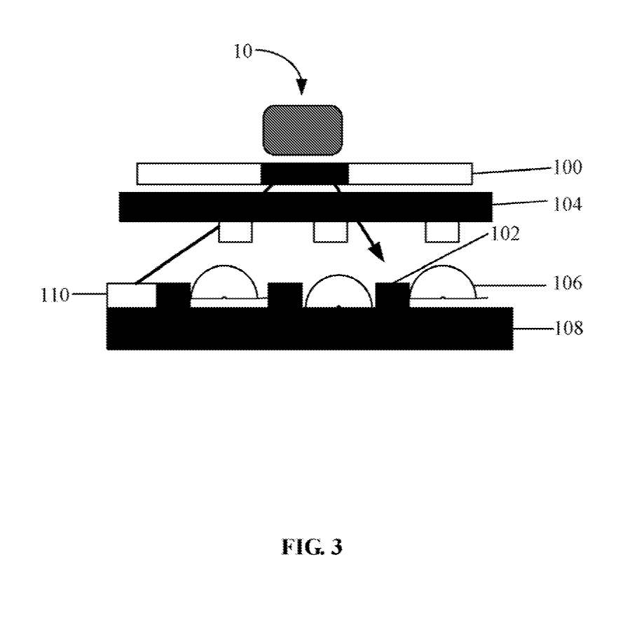

With reference to FIG. 3 and FIG. 4, a front elevational view and a top plan view of the input device 10 are shown. As illustrated in both FIG. 3 and FIG. 4, the input device 10 includes keys 100 (only one key is shown in FIG. 3), light sensors 102, a light-guide plate 104, metallic points 106, a printed circuit board (PCB) 108, and a light-emitting diode (LED) 110. When data input is detected on a key 100 (e.g, a user depresses the key 100), the LED 110 emits light on the key 100, which is reflected on each of the light sensors 102 positioned under the key 100, changing the current characteristics of the light sensors 102 from a low current to a high current.

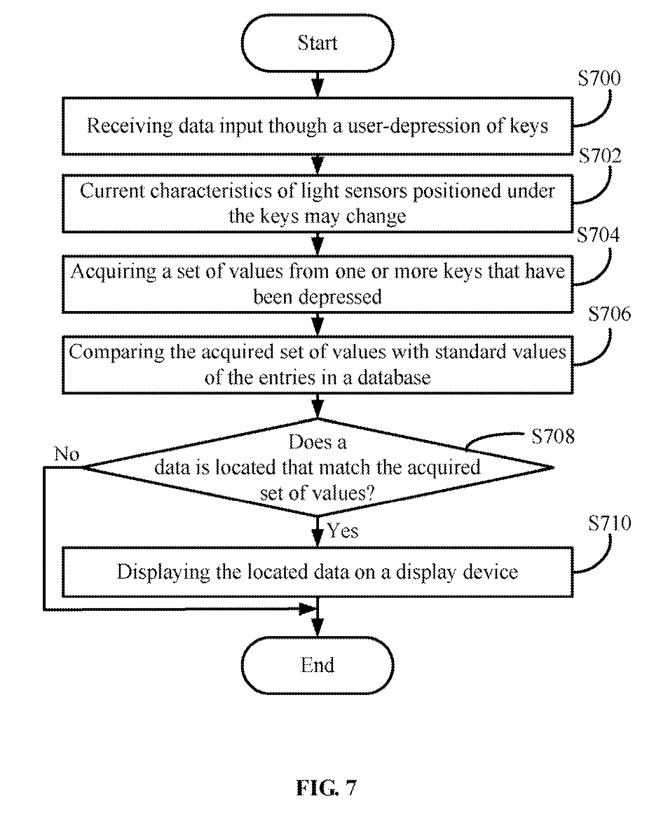

FIG. 7 is a flowchart illustrating one embodiment of a data input method for an electronic device 1 using a data input unit 12 that described in FIG. 1. Depending on the embodiment, additional blocks in the flow of FIG. 7 may be added, others removed, and the ordering of the blocks may be changed. In the embodiment, the electronic device 1 includes an input device 10 and a display device 14. The input device 10 includes keys 100, and light sensors 102 positioned under each of the keys 100. Each of the light sensors 102 has a serial number, as explained in FIG. 5, the serial number of each of the light sensors 102 are set as “1, 2, 3 . . . 20.”

In block S700, the receiving module 120 receives data input though a user-depression of the keys 100. In the embodiment, the data input may be a Chinese characters, or English words, for example.

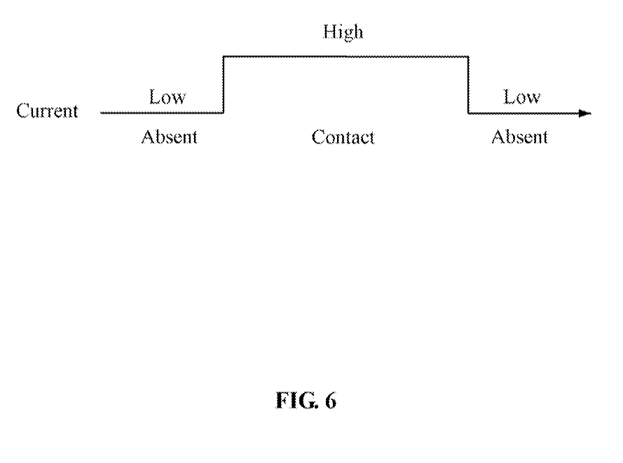

In block S702, current characteristics of the light sensors 102 positioned under the keys 100 that have been depressed may change. For example, as shown in FIG. 6, the current characteristics of each light sensor 10 register as high when contact is made with a key 100. When contact is absent from the key 100, current characteristics for each light sensor 10 register as low.

In block S704, the acquiring module 122 acquires a set of values from one or more keys that have been depressed. In the embodiment, the acquired set of values includes serial numbers of the light sensors 102 positioned under each of the keys 100, and a current value change sequence of the light sensors 102 related to the one or more keys 100 that have been depressed. The current value change sequence includes a low current value changing to a high current value or a high current value changing to a low current value.

In block S706, the locating module 124 compares the acquired set of values with standard values of the entries in a database 180 of the electronic device 1, to determine whether a data is located that match the acquired set of values. In the embodiment, the standard values include serial numbers of the light sensors 102 that experience a current value change sequence. It should be understood that the current value change sequence of the light sensors 102 of the keys 100 that have been depressed are related to the data input to the keys 100.

If no data in the database 180 matches the acquired set of values, the process is complete. If data is located that matches the acquired set of values, in block S710, the displaying module 126 displays the located data on the display device 14.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A data input method for an electronic device, the electronic device comprising keys and a display device, the method comprising:
receiving data input though a user-depression of the keys;
acquiring a set of values from one or more keys that have been depressed, wherein the set of values comprises serial numbers of light sensors positioned under each of the keys, and a current value change sequence of the light sensors related to the one or more keys that have been depressed;
locating data from a database of the electronic device, wherein the data comprises standard values that match the acquired set of values, by comparing the acquired set of values with the standard values of the entries in the database;
displaying the located data on the display device.

2. The method as claimed in claim 1, wherein the current value change sequence of the light sensors comprises a low current value flowing to the light sensors changing to a high current value, or a high current value flowing to the light sensors changing to a low current value.

3. The method as claimed in claim 1, wherein the electronic device further comprises a storage system operable to store the serial numbers of the light sensors.

4. The method as claimed in claim 1, wherein at least four light sensors are disposed under four different corners of each of the keys.

5. The method as claimed in claim 1, wherein the electronic device is a mobile phone, personal digital assistant, personal computer, or game machine.

6. The method as claimed in claim 1, wherein the data comprises Chinese characters and/or English words stored in a storage device of the electronic device.

7. An electronic device, comprising:
keys;
a display device;
a processor;
a storage system comprising a database and a data input unit operable to be executed by the processor, the data input unit comprising:
a receiving module to receive data input though a user-depression of the keys;
an acquiring module to acquire a set of values from one or more keys that have been depressed, wherein the set of values comprises serial numbers of light sensors positioned under each of the keys, and a current value change sequence of the light sensors related to the one or more keys that have been depressed;
a locating module to locate data from the database, wherein the data comprises standard values that match the acquired set of values, by comparing the acquired set of values with the standard values of the entries in the database; and
a displaying module to display the located data on the display device.

8. The electronic device as claimed in claim 7, wherein the current value change sequence of the light sensors comprises a low current value flowing to the light sensors changing to a high current value, or a high current value flowing to the light sensors changing to a low current value.

9. The electronic device as claimed in claim 7, further comprising a storage system operable to store the serial numbers of the light sensors.

10. The electronic device as claimed in claim 7, wherein at least four light sensors are respectively disposed under four different corners of each of the keys.

11. The electronic device as claimed in claim 7, wherein the electronic device is a mobile phone, personal digital assistant, personal computer, or game machine.

12. The electronic device as claimed in claim 7, wherein the data comprises Chinese characters and/or English words stored in a storage device of the electronic device.

13. A storage medium having stored thereon instructions that, when executed by a processor of an electronic device, cause the processor to implement a data input method for the electronic device, the electronic device comprising keys and a display device, the method comprising:
receiving data input though a user-depression of the keys;
acquiring a set of values from one or more keys that have been depressed, wherein the set of values comprises serial numbers of light sensors positioned under each of the keys, and a current value change sequence of the light sensors related to the one or more keys that have been depressed;
locating data from a database of the electronic device, wherein the data comprises standard values that match the acquired set of values, by comparing the acquired set of values with the standard values of the entries in the database;
displaying the located data on the display device.

14. The storage medium as claimed in claim 13, wherein the current value change sequence of the light sensors comprises a low current value flowing to the light sensors changing to a high current value, or a high current value flowing to the light sensors changing to a low current value.

15. The storage medium as claimed in claim 13, wherein the electronic device further comprises a storage system operable to store the serial numbers of the light sensors.

16. The storage medium as claimed in claim 13, wherein at least four light sensors are respectively disposed under four different corners of each of the keys.

17. The storage medium as claimed in claim 13, wherein the electronic device is a mobile phone, personal digital assistant, personal computer, or game machine.

18. The storage medium as claimed in claim 13, wherein the data comprises Chinese characters and/or English words stored in a storage device of the electronic device.
